(19) United States
(12) Patent Application Publication
(10) Pub. No.: US 2006/0082015 A1
(43) Pub. Date: Apr. 20, 2006

(54) Surgical implant shaping instrument, surgical system and method

(75) Inventors: Harri Happonen, Tampere (FI); Andreas Posel, Ylinen (FI); Vesa Vuorisalo, Tampere (FI); Petri Koho, Tampere (FI)

Correspondence Address: BANNER & WITCOFF, LTD., 28 STATE STREET, 28th FLOOR, BOSTON, MA, 02109-9601, US

(73) Assignee: Inion Ltd., Tampere (FI)

(21) Appl. No.: 10/954,624

(22) Filed: Sep. 30, 2004

(51) Int. Cl. B27N 3/08

(52) U.S. Cl. 264/239

(57) ABSTRACT

A surgical implant shaping instrument, a surgical system, and a method for shaping a surgical implant into conformance with a surface of a bony tissue. The implant shaping instrument comprises shaping means arranged in a body part, said shaping means comprising a press element having a flexible structure configured to be pushed against an implant arranged onto an underlying bony tissue so that said implant at least substantially conforms with the shape of the underlying bony tissue.

### BACKGROUND OF THE INVENTION

The invention relates generally to surgical systems and, more particularly, instruments for contouring or shaping surgical implants. More particularly the invention relates to systems and instruments for shaping an anterior cervical plate into conformance with an underlying cervical tissue.

Fixation systems including plates and fasteners for securing the plates to a bodily tissue for fixation thereof are commonly known. The use of spinal fixation plates for correction of spinal deformities and for fusion of vertebrae, for example, is well known. Typically, a plate is positioned to span bones or bone segments that need to be immobilized with respect to one another.

Spine plates are often installed posterior or anterior to the spine. In the case of anterior installations, it is often very difficult to shape a plate into a perfect conformance with the underlying cervical tissue. This is because: a) the space around the vertebrae being operated is very limited, and b) the vertebrae is situated quite far from the stoma made for the operation.

Because of imperfect shaping a plate fixed with fasteners, like screws or rivets, to the spine, may not support the spine in a perfect way. Additionally, such an imperfectly shaped plate may come into contact with and chafe against internal soft tissue structures, which can lead to more or less troublesome consequences, such as a severe inflammation.

U.S. Pat. No. 5,779,706 describes a surgical system comprising a thermoplastic, body absorbable, bodily tissue fixation plate having a plurality of through-bores and a plurality of formations having configurations adapted to substantially matingly cooperate with a heating tip of a heating wand. The plate is heated with said heating tip, and bent into conformance with an underlying bodily tissue. In spite of the heating tip being configured to minimize the likelihood of damage to the surrounding tissue, there is always a risk that the heating tip, for some reason, can cause some damage to a bodily tissue. Furthermore, the described system and method require lot of time consuming operational steps.

### BRIEF DESCRIPTION OF THE INVENTION

The object of this invention is to provide a new solution to the problems described above.

The invention relates to a surgical implant shaping instrument comprising a body part, and shaping means arranged in the body-part, said shaping means comprising a press element having a flexible structure configured to be pushed against an implant arranged onto an underlying bony tissue so that said implant conforms at least substantially the shape of the underlying bony tissue.

The invention also relates to a surgical system comprising a plate made of a material malleable at a certain temperature range, and an upper surface and a lower surface, and a surgical implant shaping instrument, comprising a body-part and shaping means arranged in the body-part, said shaping means comprising a press element having a flexible structure configured to be pushed against the plate and to conform the lower surface at least substantially into conformation with underlying bony tissue.

The invention further relates to a method for shaping surgical implant into conformance with a surface of tissue, said implant being malleable in a certain temperature range, the method comprising the steps of:

arranging the implant in a malleable state onto the surface of tissue,

arranging a surgical implant shaping instrument onto the implant in the way that said implant is between the instrument and the surface of tissue, said instrument comprising a body part and shaping means arranged in the body-part, said shaping means comprising a press element having a flexible structure configured to be pushed against the implant arranged onto the underlying tissue, and

pressing the implant against the surface of tissue with said press element so that said implant conforms at least substantially the shape of the underlying tissue.

An advantage of the instrument, the system and the method according to the invention is that the implant to be fixed to the underlying bony tissue can be conformed into conformance with said underlying bony tissue in a reliable, safe and fast way.

According to an embodiment of the invention, the press element comprises a flexible polymer material element, e.g. elastomeric material element, which polymer material may be foamed. The press element may have a pillow-like structure. An advantage of the embodiment is that a surface of a flexible polymer material element is capable of adapting to a very complicated shape of the bony tissue to be fixated. Additionally, the pillow-like structure may come into contact with the whole upper surface of the implant and, thanks to that, force the implant over its entire area into conformance with the underlying tissue. Furthermore, it is quite simple to manufacture polymer material elements of different stiffness and shapes. Therefore, an element having the precise stiffness and other characters needed can be selected according to the operational needs, properties of the tissue to be fixated and properties of the implant to be used in an operation.

According to an embodiment of the invention, the press element is detachably arranged in the body part. An advantage of the embodiment is that if necessary, the press element can be changed even during operation. Furthermore, a detachable press element is very suitable as a disposable element that needs not to be sterilized after use.

According to an embodiment of the invention, the instrument further comprises an implant holding device having holding means for holding the implant during its fixation to the underlying bony tissue. The press element is arranged movably with respect to said holding means. Preferably, the implant holding device is detachably arranged with respect to the body part of the instrument. An advantage of the embodiment is that the implant holding device facilitates handling of a typically small implant to be fixed at the operation site as well as during its preoperative handling.

### BRIEF DESCRIPTION OF THE FIGURES

The invention is now described in greater detail in the attached drawings, in which

FIG. 1 is a schematic perspective view of a surgical system according to the invention,

FIG. 2 is a schematic perspective view of a detail of the surgical system illustrated in FIG. 1,

FIG. 3 is a schematic perspective view of a detail of the surgical system illustrated in FIG. 1,

FIG. 4a is a schematic view of a step of a method according to the invention,

FIG. 4b is a schematic view of another step of the method illustrated in FIG. 4a,

FIG. 4c is a schematic view of still another step of the method illustrated in FIG. 4a,

FIG. 4d is a schematic view of still another step of the method illustrated in FIG. 4a,

FIG. 5 is a schematic side view of a plate of a second surgical system according to the invention,

FIG. 6 is a schematic perspective view of a third surgical system according to the invention,

FIG. 7 is a schematic perspective view of a detail of the surgical system illustrated in FIG. 6,

FIG. 8 is a schematic side view of a detail of a fourth surgical system according to the invention, and

FIG. 9 is a schematic side view of a detail of a fifth surgical system according to the invention.

For the sake of clarity, the figures show the invention in a simplified manner. Like reference numbers identify like elements.

### DETAILED DESCRIPTION OF THE INVENTION

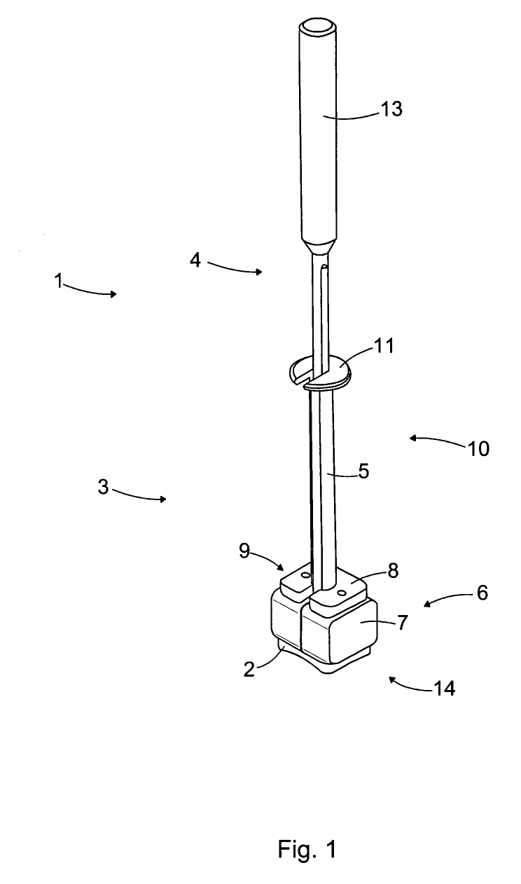

FIG. 1 is a schematic perspective view of a surgical system according to the invention. The surgical system 1 includes a fixation plate 2, a surgical implant shaping instrument 3, and an implant holding device 4.

The plate 2 is made of a polymer material or polymer composite material suitable for conforming to various shapes. Preferably, the manufacturing material of the plate 2 is a material that dissolves in the body. The material of the plate may comprise, for instance, a polymer or a copolymer of lactic acid, L-lactide, D-lactide, D,L-lactide, mesolactide, glycolic acid, glycolide or the like and optionally some other polymer or copolymer of a cyclic ester which is copolymerizable with lactide. The base material may also contain other co-monomers which impart desired properties to the material, such as α, β and γ-hydroxybutyric acid, α, β and γ-hydroxyvaleric acid and other hydroxy fatty acids (C₁₁ to C₂₅), such as stearic acid, palmitic acid, oleic acid, lauric acid and the like. Accordingly, the base material can be a polylactide, polyglycolide, poly(L-lactide), poly(D-lactide), poly(L-lactide-co-D,L-lactide), poly(L-lactide-co-mesolactide), poly(L-lactide-co-glycolide), poly(L-lactide-co-ε-caprolactone), poly(D,L-lactide-co-mesolactide), poly(D,L-lactide-co-glycolide), poly(D,L-lactide-co-ε-caprolactone), poly(mesolactide-co-glycolide), poly(mesolactide-co-ε-caprolactone) or the like. The monomer units of the co-polymeric base material can be present in a ratio of 50:50 to 85:15 or in any other suitable ratio in there between. For example, suitable co-polymeric base materials include poly(L-lactide-co-D,L-lactide) 70:30, poly(L-lactide-co-D,L-lactide) 80:20, poly(L-lactide-co-glycolide) 85:15 and poly(L-lactide-co-glycolide) 80:20. It should be noted that the polymers and copolymers suitable for use as the base material are known per se and can be easily prepared by preparation methods which are well-known to a person skilled in the art.

The material may also be a blend that contains one or more of the above mentioned materials as a base material and one or more copolymer additives. A copolymer additive comprises one or more monomers, the ductility of the blend being higher at room temperature than that of pure base material. The copolymer additive may contain trimethylene carbonate (TMC) or dioxanone, for instance. Certain advantageous copolymer additives include poly(L-lactide-co-trimethylene carbonate), poly(D,L-lactide-co-trimethylene carbonate), poly(mesolactide-co-trimethylene carbonate), poly(glycole-co-trimethylene carbonate), poly(L-lactide-co-dioxanone), poly(D,L-lactide-co-dioxanone), poly(mesolactide-co-dioxanone), poly(glycolide-co-dioxanone) and the like. The proportion of copolymer additive in the blend can be, for example, 1 to 50% by weight, preferably 20 to 50% by weight and most preferably 20 to 40% by weight.

Further, the material can be a so-called combination material, i.e. composite, that may contain bio-glass, bio-ceramics, a pharmaceutical product, such as an antibiotic or growth factor, etc.

It should be noted that the manufacturing material of the plate 2 can also be a biostable polymer material, i.e. a polymer material that does not dissolve in the body. Such biostable materials include, for instance, polyolefins and polyaryletherketones.

The plate 2 comprises a plurality of through-bores through which fasteners are inserted to secure the plate 2 to an underlying bony tissue. It should be noted here that said through-bores, fasteners or an underlying bony tissue are not shown in FIG. 1 but in figures hereinafter.

The surgical implant shaping instrument 3 has a body part 5, and shaping means 6. The body part 5 has an elongated shape having a first end 9 and a second end 10. The first end 9 is provided with the shaping means 6. The second end 10 is provided with a handle 11 of the implant shaping instrument.

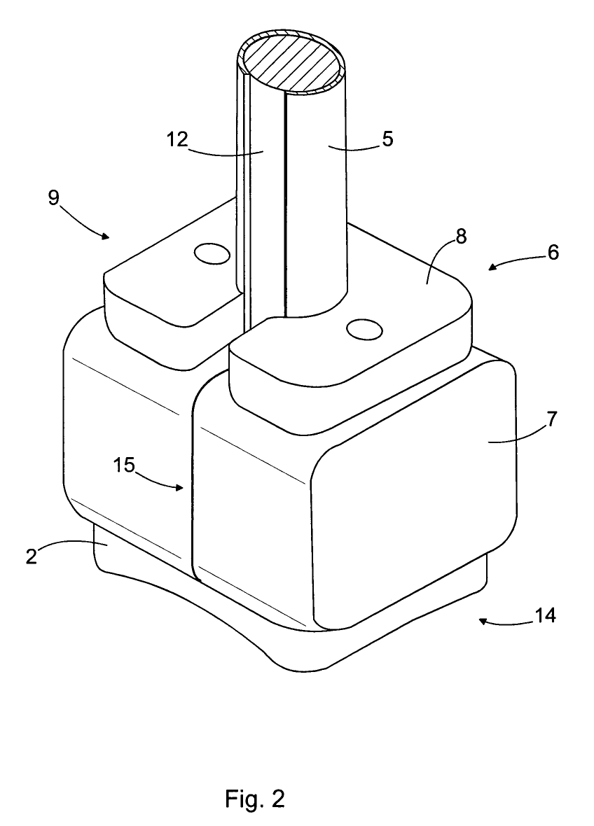

The shaping means 6 comprise a press element 7 and a body part 8. The press element 7 is detachably arranged to the body part 8 of the shaping means as well as to the body part 5 of the instrument 3. The press element 7 is an elastic component having a cube-like structure. Of course, the press element may also have some other shape. The features of the press element 7 are described in more detail in connection with FIG. 2.

An implant holding device 4 comprises an elongated body part 12. In the first end of the implant holding device 4, holding means 14 are arranged for holding the plate 2 in place during its shaping into conformance with an underlying bony tissue. The implant holding device 4 is detachably arranged to the body part 5 of the instrument 3, i.e. the instrument 3 and the holding device 4 can be separated from each other.

The shaping means 6 are attached movably to said plate holding device 4 so that the body part 5 of the shaping means 6 can be slid along the body part 5 of the plate holding device 4. This enables the location of the press element 7 to be controllable with respect to said holding means 14.

The implant holding device 4 also comprises a handle 13 at the second end of the body part 12. An operator may control the location or distance of the press element 7 and the holding means 14 by moving the handles 11, 13 with respect to each other.

The body part 5 of the shaping instrument 3 as well as the body part 8 of the shaping means may be manufactured from any suitable metal, for example stainless steel, or plastic, like polyolefin, or a plastic composite.

It should be noted that, instead of plates, also other type of surgical implants may be shaped with the instrument according to the invention.

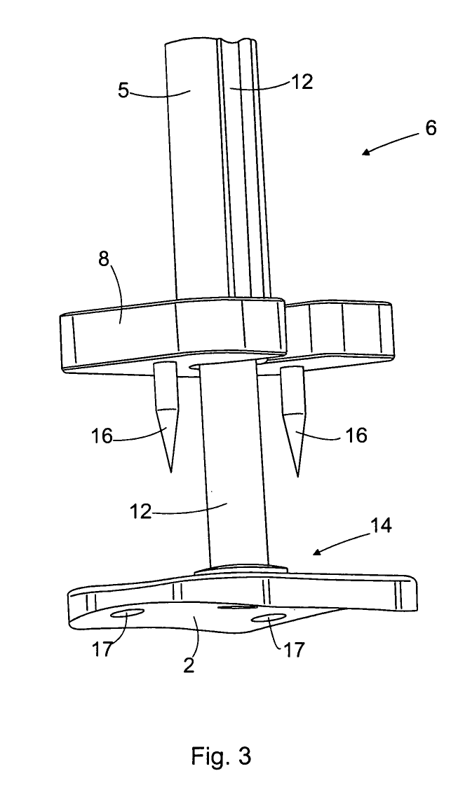

FIG. 2 is a schematic perspective view of a detail of the surgical system illustrated in FIG. 1, and FIG. 3 is another schematic perspective view of a detail of the surgical system illustrated in FIG. 1.

The press element 7 has a flexible pillow-like structure. The manufacturing material of the press element 7 is a cross-linked silicon rubber. The press element 7 may also be made of another type of elastomeric material, a plastic, or plastic composite acceptable to a surgical use. The manufacturing material may be foamed or non-foamed. The stiffness and other physical characteristics of the press element 7 have been selected according to the requirements of the operation and the implant to be used.

The press element 7 is arranged demountably around the body part 12 of the implant holding device and also fastened demountably to the body part 8 of the shaping means. The press element 7 has an interstice or opening 15 extending from an outer surface of the element to an inner surface facing the holding device's body part 12. Said interstice or opening 15 enables the operator to remove the press element 7 from the shaping means 6, or vice versa, to accommodate the press element 7 to the shaping means 6.

FIG. 3 shows a situation where the press element 7 is removed from the shaping means 6. The body part 8 of the shaping means includes two fastening spikes 16. The fastening spikes 16 are pushed into the press element 7 fitted in its place as shown in FIG. 2. In this way, the press element 7 can be firmly fastened to the body part 8 of the shaping means, but, if necessary, it can also be easily demounted from the body part 8.

According to one embodiment of the invention, the press element 7 is disposable, i.e. when it has been used in an operation it is not sterilized but disposed of.

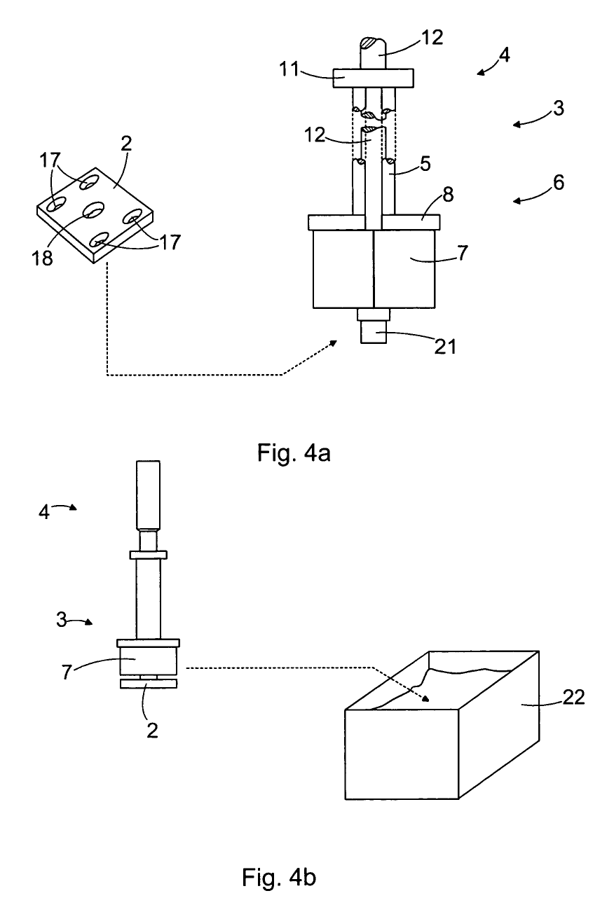

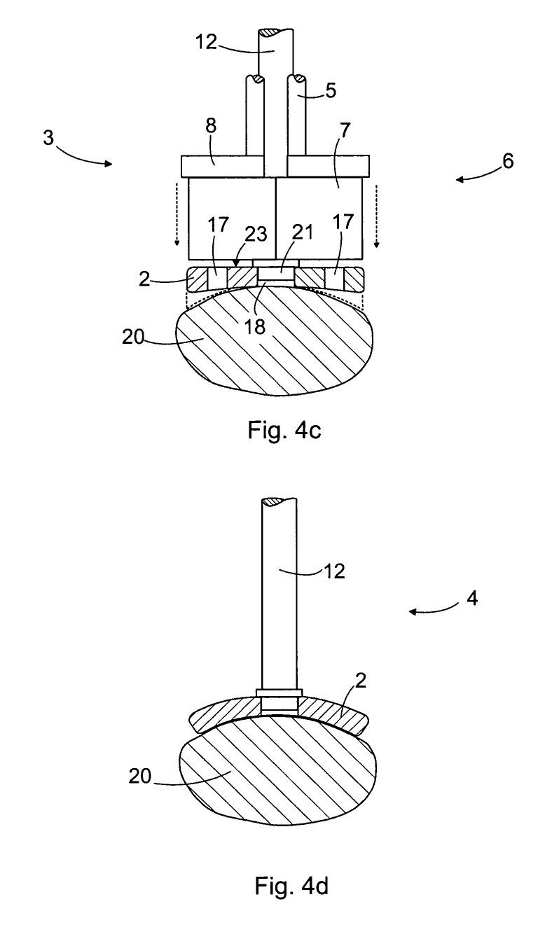

FIG. 4a is a schematic view of a step of a method according to the invention, FIG. 4b is a schematic view of another step of the method illustrated in FIG. 4a, FIG. 4c is a schematic view of still another step of the method illustrated in FIG. 4a, and FIG. 4d is a schematic view of still another step of the method illustrated in FIG. 4a. The surgical system shown in FIGS. 4a to 4d is similar to that shown in FIGS. 1 to 3.

In the step shown in FIG. 4a, an implant is attached to holding means 14 of an implant holding device 4. In the embodiment shown in FIGS. 4a to 4d, the implant is a fixation plate 2 to be fastened to an anterior column of a vertebra for correction of spinal deformity and/or for fusion of said vertebra.

First, a pin 21 of the holding means 14 is inserted into a borehole 18 arranged in the midpoint of the plate 2. The pin 21 fits into the borehole 18 tight by enough so that the plate 2 does not tall off the holding means 14 but, on the other hand, so that the holding means 14 can be detached form the plate 2 without damaging the plate 2. Generally speaking, the fitting between the holding means 14 and the plate can be arranged, for example, by an interference fit or a friction fit. The diameter of the pin 21 is constant all over its length. It is also possible that the diameter of the pin 21 expands towards its end. It is also possible that the pin 21 comprises a screw thread; the plate can also comprise a thread that fits into said thread.

In the step shown in FIG. 4b, the plate 2 attached to the holding means 14 is put in a heating device 22. The heating device 22 shown in FIG. 4b is a water bath containing heated water. The plate 2 is made of a plastic material malleable at an elevated temperature but rigid at body temperature. Said material may have a biostable character, or it can be a material that dissolves in the body. As the plate 2 is dipped in the water bath whose temperature is above body temperature, its temperature begins to rise. When the plate temperature has reached a region where its material is malleable, the plate 2 is removed away from the heating device 22 the plate 2 still being attached to the holding means 14.

The temperature region can be, for example, 50° C. to 100° C. Preferably, the temperature is 50° C. to 60° C. for plates made of polylactide-co-trimethylene carbonate, 60° C. to 70° C. for plates made of poly(L-lactide-co-D-lactide) and 70° C. to 90° C. for plates made of poly(L-lactide).

Naturally, the heating device can also be another kind of device suitable for heating the plate or another implant to a temperature needed.

It is possible that the implant shaping instrument 3 is not inserted in to the implant holding device 4 when the plate 2 is heated in the heating device 22 but only after said heating has taken place.

In the step shown in FIG. 4c, the plate 2 is arranged on a bony tissue 20 to which it is to be fastened. In this step, the temperature of the plate 2 is still in the region where its material is malleable. In other words, the plate 2 and the instrument 3 are moved quickly enough from the heating device 22 to the operation site for the temperature of the plate 2 not to drop below the malleable region. The time available for said movement depends on the material and size of the implant, the temperature at which the plate 2 is heated, the dimensions and shape of the plate 2, etc. The faster the plate 2 is moved from the heating device 22 to the operation site, the more time operators have to shape the plate.

Still in a malleable state, the plate is bent into conformance with an underlying bony tissue 20. This is carried out by pushing the press element 7 with the help of the handle 11 of the shaping instrument against the plate 2 or its upper surface 23. The pressure caused by the press element 7 forces the plate 2 to press against the underlying bony tissue 20 and to adapt the shape of surface of said tissue 20. Dashed lines in FIG. 4c denote the position and shape of the press element and the plate 2. It should be noted that the bone tissue against which the plate is pressed may also be a bone graft, i.e. a new bony tissue placed into or around broken bone and taken from the patient's own healthy bony tissue or from frozen, donated bony tissue.

Because of the flexible structure of the press element 7, the plate is pressed against the bony tissue 20 substantially in its entirety and the plate shapes into conformance with the bony tissue 20.

The press element 7 is pressed against the plate 2 until the temperature of the plate material is dropped below the region where the material is malleable, i.e. until the plate material is rigid again. The duration of such a temperature transition varies depending on the temperature at which the plate 2 is heated, material characteristics of the plate material, dimensions and shape of the plate 2, heat transfer rate of the press element 7, etc.

In the step shown in FIG. 4d the plate is rigid again because of its temperature has dropped under the temperature region where the material of the plate is malleable. The plate 2 has substantially precisely adapted the shape of the surface of the underlying bony tissue 20 and the press element 7 is lifted off the plate 2. This can be carried out by lifting the handle 11 of the shaping means and sliding the body part 5 of the shaping instrument upwards along the body part 12 of the implant holding device. The shaping means 6 may be detached from the implant holding device, or alternatively, the shaping means 6 may just be lifted off the plate 2, keeping the body parts 5, 12 of the shaping instrument and the holding device together. Nevertheless, the implant holding device 4 and the plate 2 are kept in place in contact with the underlying bony tissue 20.

In subsequent steps of the fastening operation, fixation holes are drilled and optionally tapped in the underlying bony tissue 20, and fasteners securing the plate 2 to the bony tissue 20 are inserted into the through-bores and said fixation holes. All above-mentioned subsequent steps are preferably carried out when the plate 2 is still kept in place with the implant holding device 4. The plate 2 is detached from the implant holding device 4 only after it has fastened to the tissue 20.

Said fasteners can be, for example, screws or rivet-type fasteners or some other type of fasteners known per se. Said subsequent steps are commonly known per se; therefore, they are not described in detail herein. The plate may also be fastened to the tissue 20 with a bone glue.

It should be noted here that the implant may also be made of materials being malleable at body temperature (37° C.) or even at room temperature (20° C.). It is also possible that the implant material comprises a plasticizer that is adapted to substantially reduce the rigidity of the implant and that substantially exits from the implant after coming into contact with tissue fluids of the organ system in such a manner that the bending resistance of the implant prior to the insertion of the implant into the organ system is substantially lower than after its insertion into the organ system. This kind of materials are disclosed in a co-pending U.S. patent application Ser. No. 10/006,796, which is hereby incorporated by reference in its entireties for all purposes.

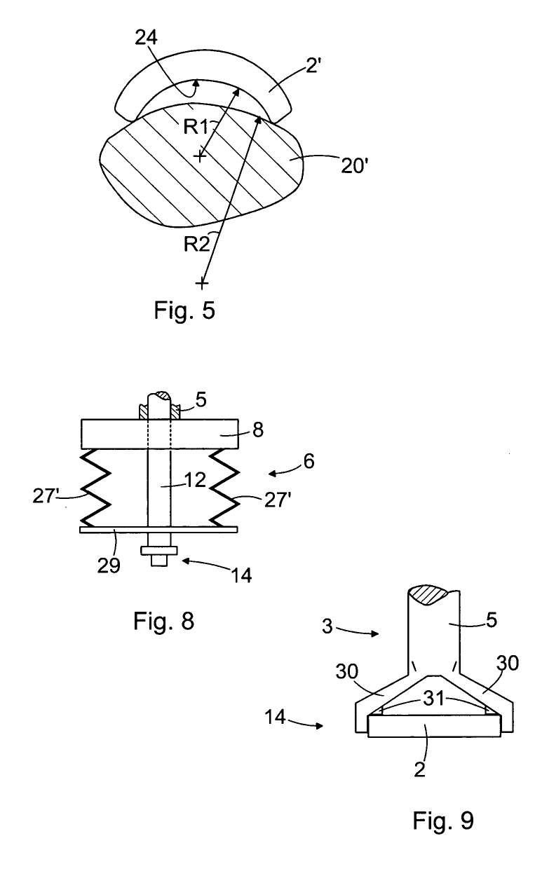

FIG. 5 is a schematic side view of a plate of a second surgical system according to the invention. In the embodiment shown in FIG. 5, a lower surface 24 of a plate 2′ has a curved shape. The radius of the lower surface 24 is denoted with R1. The surface of an underlying bony tissue 20′ also has a curved shape, the radius thereof being denoted with R2. R1 is shorter than R2, which is contrary to the situation shown in FIG. 4c. Also in the situation shown in FIG. 5 an implant shaping instrument according to the invention is capable of shaping the plate 2′ into conformance with the underlying body tissue 20′.

It should be noted here that instead of a plate 2, the implant of the surgical system according to the invention may also be some other type of implant that needs to be shaped into conformation with a tissue. Such an implant may be, for example, a panel, a mesh, or a sheet.

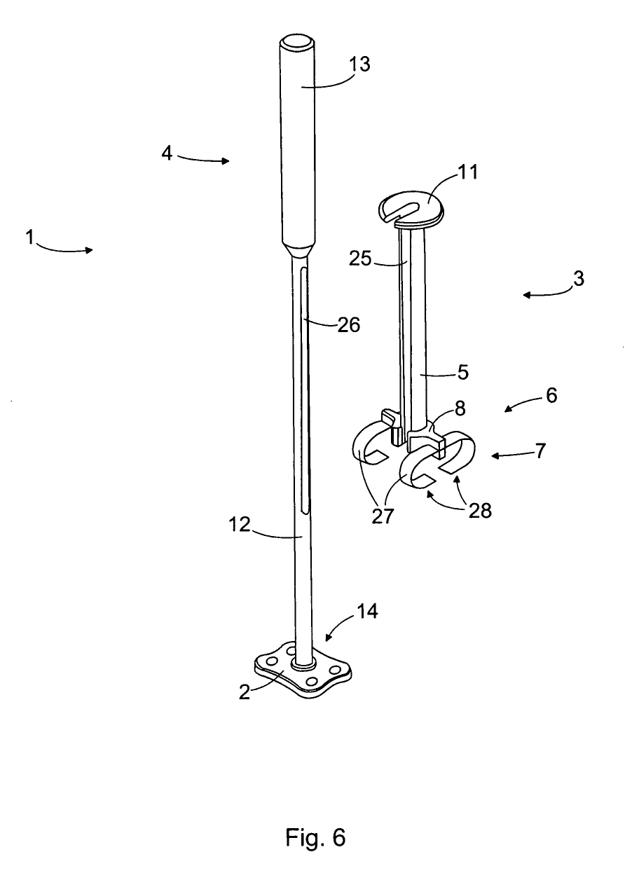

FIG. 6 is a schematic perspective view of a third surgical system according to the invention, and FIG. 7 is a schematic perspective view of a detail of the surgical system illustrated in FIG. 6.

A surgical system 1 comprises an implant shaping instrument 3 and an implant holding device 4, which are detached from each other in FIG. 1, and in turn, arranged in to each other in FIG. 7.

A body part 5 of the implant shaping instrument 3 has an elongated, round shape. One side of the body part 5 of the implant shaping instrument 3 is provided with a deep longitudinal first groove or a channel 25. The first groove 25 also extends through a handle 11 of the implant shaping instrument and a body part 8 of shaping means 6.

The body part 12 of the implant holding device 4 also has an elongated, round shape. Longitudinal second grooves 26 are provided in an upper section of the body part 12 of the implant holding device.

The first groove 25 is dimensioned so that the body part 5 of the shaping instrument can be attached to or detached from the body part 5 of the implant holding device only if the first groove 25 and the second grooves 26 are positioned against each other. The shaping instrument 3 can be slid on the body part 5 of the implant holding device such that a position of the shaping means 6 can vary with respect to holding means 14 of the implant holding device.

According to another embodiment of the surgical implant shaping instrument of the invention, the body part 5 of the instrument includes an interlocking part made of an elastic material, such as plastic. Said interlocking part is shaped such that it is elastically deformed during assembly and disassembly of the body part 5 and the body part 12 of the implant holding device, and interferes with a cooperation portion on the body part 12 of the implant holding device to resist separation.

The shaping means 6 comprise a body part 8 and a press element 7 arranged thereto. The press element 7 comprises spring elements 27. In the embodiment shown in FIGS. 6 and 7 two spring elements 27 are provided. A spring element 27 is made of flexible, preferably elastically flexible, metal, plastic or plastic composite. The spring element 27 has two ends that have been bent downwards to make two contact surfaces 28. The contact surfaces 28 press against an implant to be shaped into conformance with a bony tissue.

There is a total of four contact surfaces 28 in the shaping means 6 shown in FIGS. 6 and 7. The shape and number of spring elements in FIGS. 6 and 7 are only intended to illustrate one embodiment of the shaping means 6, and, naturally, the spring elements can be provided in different shapes and their number may vary.

The whole shaping element 3 may be disposable or non-disposable. In one embodiment of the invention, the body part 5 of the shaping element is non-disposable but the spring elements 27 are disposable.

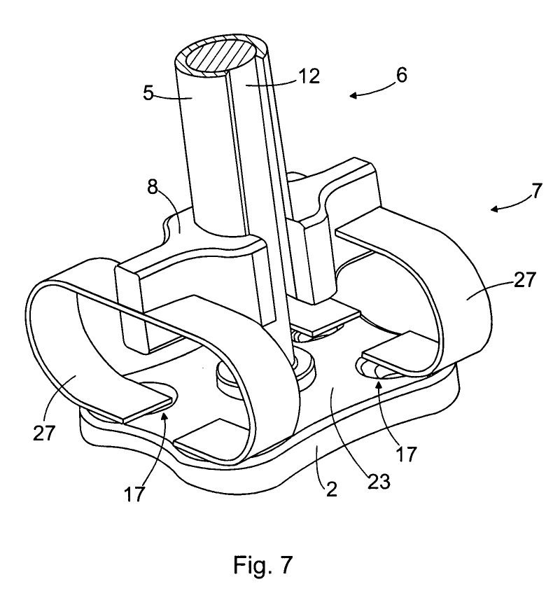

FIG. 8 is a schematic side view of a detail of a fourth surgical system according to the invention. Shaping means 6 comprise a body part 8 and a contact surface plate 29. The contact surface plate 29 is made of an elastic material, for instance plastic or metal. A body part 12 of an implant holding device goes through the body part 8 and the contact surface plate 29.

Between the contact surface plate 29 and the body part 8, several spring elements 27′ are arranged. When the contact surface plate 29 is pushed against an underlying surface, spring elements 27′ allow the contact surface plate 29 to shape into conformance with said surface. The contact surface plate 29 is adapted to press an implant attached to holding means 14 into conformance with a bony surface as discussed above.

FIG. 9 is a schematic side view of a detail of a fifth surgical system according to the invention. An implant shaping instrument 3 is provided for shaping an implant of a plate type. The shaping instrument 3 includes a body part 5 and holding means 14 arranged to a first end of said body part 5. The holding means 14 comprise a plurality of support arms 30 made of an elastic material. The support arms are arranged and dimensioned so that the plate 2 is pinched between them. As the plate 2 is pressed against an underlying bony tissue, the elastic support arms 30 force the plate 2 to confirm with said tissue.

The drawings and the related description are only intended to illustrate the inventive concept. The details of the invention may vary within the scope of the claims.

1. A surgical implant shaping instrument, comprising:
a body part,
shaping means arranged in the body part, said shaping means comprising a press element having a flexible structure configured to be pushed against an implant arranged onto an underlying bony tissue so that said implant at least substantially conforms with the shape of the underlying bony tissue.

2. An instrument according to claim 1, wherein the press element comprises a flexible polymer material.

3. An instrument according to claim 2, wherein the flexible polymer material is an elastic material.

4. An instrument according to claim 3, wherein the elastic material is a silicone elastomer.

5. An instrument according to claim 3, wherein the flexible polymer material is a foamed polymer material.

6. An instrument according to claim 1, wherein the press element has a pillow-like structure.

7. An instrument according to claim 1, wherein the press element comprises at least one flexible spring element.

8. An instrument according to claim 7, wherein the flexible spring element is made of a flexible metal.

9. An instrument according to claim 7, wherein the flexible spring element is made of an elastic plastic.

10. An instrument according to claim 1, wherein the instrument is a disposable instrument.

11. An instrument according to claim 1, wherein the press element is detachably arranged in the body part.

12. An instrument according to claim 11, wherein the press element is made of foamed polymer material and the body part comprises at least one fastening spike arranged to intrude into said foamed polymer material for attaching the press element to the body part.

13. An instrument according to claim 11, wherein the press element is disposable.

14. An instrument according to claim 1, further comprising
an elongated body, the press element being arranged to a first end of said body, and
handle means arranged to a second end of said body.

15. An instrument according to claim 1, further comprising an implant holding device having holding means for holding the implant during its shaping into conformance with the underlying bony tissue,
wherein the press element is movably arranged with respect to said holding means.

16. An instrument according to claim 15, wherein the implant holding device is detachably arranged with respect to the body part of the instrument.

17. An instrument according to claim 15, wherein the implant holding device comprises an elongated body part, and the body part of the instrument is arranged slidably with respect to said elongated body part.

18. An instrument system according to claim 15, wherein the implant holding device is configured to hold an implant of a plate type.

19. A surgical system, comprising:
a plate, made of a material malleable within a certain temperature range, and an upper surface and a lower surface,
a surgical implant shaping instrument, comprising a body part and shaping means arranged in the body part, said shaping means comprising a press element having a flexible structure configured to be pushed against the plate and to conform the lower surface at least substantially into conformation with an underlying bony tissue.

20. A surgical system according to claim 19, wherein the plate is made of a body absorbable plastic material.

21. A surgical system according to claim 19, wherein the temperature range is above body temperature.

22. A surgical system according to claim 21, wherein the temperature range is from 50° C. to 100° C.

23. A surgical system according to claim 19, further comprising an implant holding device having holding means for holding the plate during its shaping into conformance with the underlying bony tissue, the surgical implant shaping instrument being attached to said plate holding device so that the press element is movably arranged with respect to said holding means.

24. A surgical system according to claim 23, wherein the implant holding device is detachably arranged with respect to the body part of the instrument.

25. A surgical system according to claim 19, wherein the plate is a fixation plate for stabilizing a spine.

26. A method for shaping a surgical implant into conformance with a surface of a tissue, said implant being malleable within a certain temperature range, the method comprising the steps of:
arranging the implant in a malleable state onto the surface of a tissue,
arranging a surgical implant shaping instrument onto the implant such that said implant is between the instrument and the surface of a tissue, said instrument comprising a body part and shaping means arranged in the body part, said shaping means comprising a press element having a flexible structure configured to be pushed against the implant arranged onto the underlying tissue, and
pressing the implant against the surface of a tissue with said press element so that said implant at least substantially conforms with the shape of the underlying tissue.

27. A method according to claim 26, wherein said temperature range is above body temperature, and the implant is heated to a temperature within said temperature range in a heating device prior to arranging the implant onto the surface of a tissue.

28. A method according to claim 27, wherein the implant is pressed against the surface of a tissue with said press element until the temperature of the implant is below said temperature range.

29. A method according to claim 26, wherein the implant is attached to a holding device, said holding device comprising holding means for holding the implant during its shaping into conformance with the underlying tissue.
